(19) United States
(12) Patent Application Publication
(10) Pub. No.: US 2010/0118116 A1
(43) Pub. Date: May 13, 2010

(54) METHOD OF AND APPARATUS FOR PRODUCING A MULTI-VIEWPOINT PANORAMA

(76) Inventors: Wojciech Nowak Tomasz, Lodzki (PL); Rafal Jan Gliszczynski, Lodz (PL)

Correspondence Address: HARNESS, DICKEY & PIERCE, P.L.C., P.O. BOX 8910, RESTON, VA, 20195, US

(21) Appl. No.: 12/451,838

(22) PCT Filed: Jun. 28, 2007
(86) PCT No.: PCT/NL2007/050319

§ 371 Date: Jan. 6, 2010

(51) Int. Cl. H04N 7/00; H04N 7/18

(52) U.S. Cl. 348/36; 348/148; 348/E07.001; 348/E07.085

(57) ABSTRACT

A method of producing a multi-viewpoint panorama of a roadside is disclosed. In at least one embodiment, the method includes acquiring a set of laser scan samples obtained by at least one terrestrial based laser scanner mounted on a moving vehicle, wherein each sample is associated with location data and orientation data; acquiring at least one image sequence, wherein each image sequence is obtained by use of a terrestrial based camera mounted on the moving vehicle, wherein each image of the at least one image sequences is associated with location and orientation data; extracting a surface from the set of laser scan samples and determining the location of the surface in dependence of the location data associated with the laser scan samples; and producing a multi-viewpoint panorama for the surface from the at least one image sequence in dependence of the location of the surface and the location and orientation data associated with each of the images.

### FIELD OF THE INVENTION

The present invention relates to a method of producing a multi-viewpoint panorama. The present invention further relates to a method of producing a roadside panorama from multi viewpoint panoramas. The invention further relates to an apparatus for a multi-viewpoint panorama, a computer program product and a processor readable medium carrying said computer program product. The invention further relates to a computer-implemented system using said roadside panoramas.

### PRIOR ART

Nowadays, people use navigation devices to navigate themselves along roads or use map displays on the internet. Navigations devices show in their display a planar perspective, angle perspective (bird view) or variable scale “2D” map of location. Only information about the roads or some simple attribute information about areas, such as lakes and parks are shown in the display. This kind of information is really an abstract representation of the location and does not show what can be seen by a human or by a camera positioned at the location (in reality or virtually) shown in the display. Some internet applications show top looking down pictures taken from satellite or airplane and still fewer show a limited set of photographs taken from the road, perhaps near the location (real or virtual) of the user and facing in generally the same direction as the user intends to look.

There is a need for more accurate and realistic roadside views in future navigation devices and internet applications. The roadside views enables a user to see what can be seen at a particular location and to verify very easily whether the navigation device uses the right location when driving or verify that the place of interested queried on the internet is really the place they want or just viewing the area in greater detail for pleasure or business reasons. In the display the user can than see immediately whether the buildings seen on the display correspond to the building he can see at the roadside or envision from memory or other descriptions. A panorama image produced from images that are captured from different viewpoints is considered to be multi-viewpoint or multi-perspective. Another type of panorama image is a slit-scan panorama. In their simplest form, a strip panorama exhibits orthographic projection along the horizontal axis, and perspective projection along the vertical axis.

A system for producing multi-viewpoint panoramas is known from Photographing long scenes with multi-viewpoint panoramas, Aseem Agarwala, et al, ACM Transactions on Graphics (Proceedings of SIGGRAPH 2006), 2006. A system for producing multi-viewpoint panoramas of long, roughly planar scenes, such as facades of buildings along a city street, produces from a relatively sparse set of photographs captured with a handheld still camera. A user has to identify the dominant plane of the photographed scene. Then, the system computes a panorama automatically using Markov Random Field optimization.

Another technique for depicting realistic images of what is around is to develop a full 3D model of the area and then apply realistic textures to the outer dimensions of each building. The application, such as that in the navigation unit or on the internet, can then use 3D rendering software to construct a realistic picture of the surrounding objects.

### SUMMARY OF THE INVENTION

The present invention seeks to provide an alternative method of producing multi-viewpoint panoramas and an alternative way of providing a high quality easy to interpret set of images representing a virtual surface with near photo quality which are easy to manipulate to obtain pseudo realistic perspective view images without the added cost and complexity of developing a full 3D model.

According to the present invention, the method comprises:

acquiring a set of laser scan samples obtained by a laser scanner mounted on a moving vehicle, wherein each sample is associated with location data;

acquiring at least one image sequence, wherein each image sequence has been obtained by means of a terrestrial based camera mounted on the moving vehicle, wherein each image of the at least one image sequences is associated with location and orientation data;

extracting a surface from the set of laser scan samples and determining the location of said surface in dependence of the location data associated with the laser scan samples;

producing a multi-viewpoint panorama for said polygon from the at least one image sequence in dependence of the location of the surface and the location and orientation data associated with each of the images.

The invention is based on the recognition that a mobile mapping vehicle which drives on the surface of the earth, records surface collected geo-position image sequences with terrestrial based cameras. Furthermore, the mobile mapping vehicle records laser scan samples which enables software to generate a 3D representation of the environment of the mobile mapping vehicle from the distance information from the laser scanner samples. The position and orientation of the vehicle is determined by means of a GPS receiver and an inertial measuring device, such as one or more gyroscopes and/or accelerometers. Moreover, the position and orientation of the camera with respect to the vehicle and thus with respect to the 3D representation of the environment is known. To be able to generate a visually attractive multi viewpoint panorama, the distance between the camera and the surface of the panorama has to be known. The panorama can represent a view of the roadside varying from a building surface up to a roadside panorama of a street. This can be done with existing image processing techniques. However, this needs a lot of computer processing power. According to the invention, the surface is determined by processing the laser scanner data. This needs much less processing power to determine the position of a surface than using only image processing techniques. Subsequently, the multi viewpoint panorama can be generated by projecting the images or segments of images recorded onto the determined surface.

The geo-positions of the cameras and laser scanners are accurately known by means of an onboard positioning system (e.g. a GPS receiver) and other additional position and orientation determination equipment (e.g. Inertial Navigation System INS).

A further improvement of the invention is the ability to provide imagery that shows some of the realism of a 3D image, without the processing time necessary to compute the 3D model nor the processing time necessary to render a full 3D model. A 3D model comprises a plurality of polygons or surface. Rendering a full 3D model requires to evaluate for each of the polygons whether they could be seen when the 3D model is viewed from a particular side. If a polygon can be seen, the polygon will be projected on the imagery. The multi viewpoint panorama according to the invention is only one surface for a whole frontage.

Further embodiments of the invention have been defined in the dependent claims.

In an embodiment of the invention producing comprises:

detecting one or more obstacles obstructing in all images of the at least one image sequences to view a part of the surface;

projecting a view of one of the one or more obstacles to the multi-viewpoint panorama. The laser scanner samples enables us to detect for each image which obstacles are in front of the camera and before the position of the plane of the multi viewpoint panorama to be generated. These features enable us to detect which parts of the plane are not visible in any of the images and should be filled with an obstacle. This allows us to minimize the number of obstacles visible in the panorama in front of facades and consequently to exclude from the multi viewpoint panorama as much as possible obstacles not obstructing in all of the images to view a part of the surface. This enables us to provide a multi viewpoint panorama of a frontage with a good visual quality.

In a further embodiment of the invention producing further comprises:

determining for each of the detected obstacle whether it is completely visible in any of the images;

if a detected obstacle is completely visible in at least one image, projecting a view of said detected object from one of said at least one image to the multi-viewpoint panorama. These features allows us to reduce the number of obstacles which will be visualized partially in the panorama. This improves the attractiveness of the multi viewpoint panorama.

In an embodiment of the invention the multi viewpoint panorama is preferably generated from parts of images having an associated looking angle which is most perpendicular to the polygon. This feature enables us to generate from the images the best quality multi viewpoint panorama.

In an embodiment of the invention a roadside panorama is generated by combining multi viewpoint panoramas. A common surface is determined for a roadside panorama parallel to but a distance from a line, e.g. centerline of a road. The multi viewpoint panoramas having a position different from the common surface are projected on the common surface to represent each of the multi viewpoint panoramas as it was seen at a distance equivalent to the distance between the surface and the line. Accordingly, a panorama is generated which visualized the objects in the multi viewpoint panoramas having a position different from the common surface, now as seen from the same distance. As much as possible obstacles have been removed from the multi viewpoint panoramas to obtain the best visual quality, a roadside panorama is generated wherein many of the obstacles along the road will not be visualized.

The roadside panorama according to the invention provides the ability to provide imagery that shows some of the realism of a 3D view of a street, without the processing time necessary to render a full 3D model of the buildings along said street. Using a 3D model of said street to provide the 3D view of the street would require to determine for each building, or part of each building, along the street whether it is seen and subsequently to render each 3D model of the buildings, or parts thereof, into the 3D view. Imagery that shows some of the realism of a 3D view of a street can easily be provided with the roadside panoramas according to the invention. The roadside panorama represents the buildings along the street when projected onto a common surface. Said surface can easily be transformed into a pseudo-perspective view image by projecting sequentially the columns of pixels of the roadside panorama on the 3D view, starting with the column of pixels with the farthest position from the viewing position up to the column of pixels with nearest position from the viewing point. In this way a realistic perspective view image can be generated for the surfaces of the left and right roadside panorama, resulting in a pseudo realistic view of a street. Only two images representing two surfaces are needed instead of a multitude of polygons when using 3D models of the buildings along the street.

The present invention can be implemented using software, hardware, or a combination of software and hardware. When all or portions of the present invention are implemented in software, that software can reside on a processor readable storage medium. Examples of appropriate processor readable storage medium include a floppy disk, hard disk, CD ROM, DVD, memory IC, etc. When the system includes hardware, the hardware may include an output device (e.g. a monitor, speaker or printer), an input device (e.g. a keyboard, pointing device and/or a microphone), and a processor in communication with the output device and processor readable storage medium in communication with the processor. The processor readable storage medium stores code capable of programming the processor to perform the actions to implement the present invention. The process of the present invention can also be implemented on a server that can be accessed over telephone lines or other network or internet connection.

### SHORT DESCRIPTION OF DRAWINGS

The present invention will be discussed in more detail below, using a number of exemplary embodiments, with reference to the attached drawings that are intended to illustrate the invention but not to limit its scope which is defined by the annexed claims and its equivalent embodiment, in which

FIG. 1 shows a MMS system with a camera and a laser scanner;

FIG. 2 shows a diagram of location and orientation parameters;

FIG. 3 shows a block diagram of a computer arrangement with which the invention can be performed;

FIG. 4 is a flow diagram of an exemplar implementation of the process for producing road information according to the invention;

FIG. 5 shows a histogram based on laser scan samples;

FIG. 6 shows a exemplar result of polygon detection;

FIG. 7 shows a perspective view of the projection of a source image on a virtual plane;

FIG. 8 show a top view of the projection of a source image on a virtual plane;

FIG. 9 show a side view of the projection of a source image on a virtual plane;

FIG. 10 shows a top view of two cameras on different positions recording the same plane;

FIG. 11 shows the perspective view images from the situation shown in FIG. 10;

FIG. 12 illustrates the process of composing a panorama from two images;

FIG. 13 shows a top view of two cameras on different positions recording the same plane;

FIG. 14 shows the perspective view images from the situation shown in FIG. 13;

FIG. 15a-d show an application of the panorama,

FIG. 16a-e illustrates a second embodiment of finding areas in source images from generating a multi viewpoint panorama,

FIG. 17 shows a flowchart of an algorithm to assign the parts of the source images to be selected; and

FIG. 18 shows another example of a roadside panorama.

### DETAILED DESCRIPTION OF EXEMPLARY EMBODIMENTS

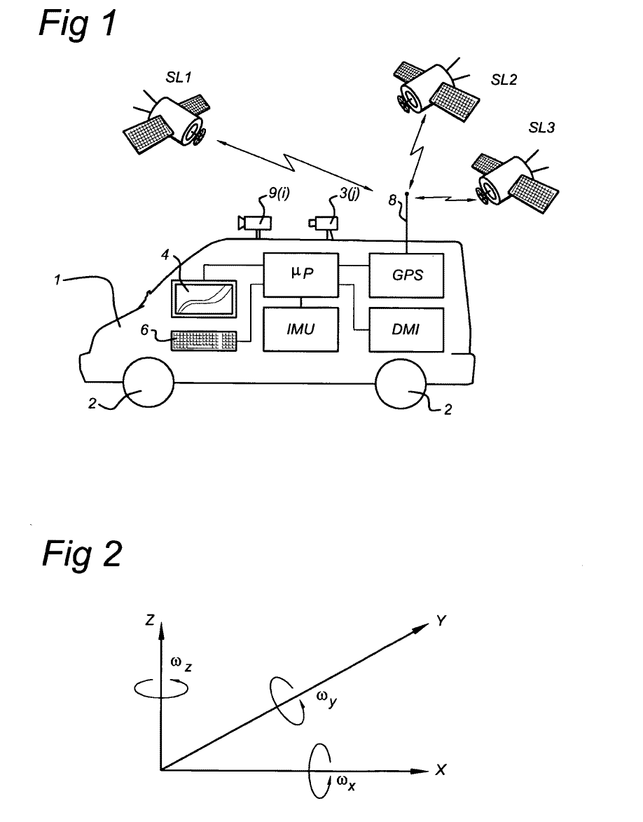

FIG. 1 shows a MMS system that takes the form of a car 1. The car 1 is provided with one or more cameras 9(i), i=1, 2, 3, . . . I, and one or more laser scanners 3(j), j=1, 2, 3, . . . J. The looking angle or the one or more cameras 9(i) can be in any direction with respect to the driving direction of the car 1 and can thus be a front looking camera, a side looking camera or rear looking camera, etc. Preferably, the angle between the driving direction of the car 1 and the looking angle of a camera is within the range of 45 degree-135 degree on either side. The car 1 can be driven by a driver along roads of interest. In an exemplar embodiment two side looking cameras are mounted on the car 1, wherein the distance between the two cameras is 2 meters and the looking angle of the cameras is perpendicular to the driving direction of the car 1 and parallel to the earth surface. In another exemplar embodiment two cameras have been mounted on the car 1, the cameras having a horizontal looking angle to one side of the car and a forward looking angle of about 45° and 135° respectively. Additionally, a third side looking camera having an upward looking angle of 45°, may be mounted on the car. This third camera is used to capture the upper part of buildings at the roadside.

The car 1 is provided with a plurality of wheels 2. Moreover, the car 1 is provided with a high accuracy position determination device. As shown in FIG. 1, the position determination device comprises the following components:

a GPS (global positioning system) unit connected to an antenna 8 and arranged to communicate with a plurality of satellites SLi (i=1, 2, 3, . . . ) and to calculate a position signal from signals received from the satellites SLi. The GPS unit is connected to a microprocessor μP. Based on the signals received from the GPS unit, the microprocessor μP may determine suitable display signals to be displayed on a monitor 4 in the car 1, informing the driver where the car is located and possibly in what direction it is traveling. Instead of a GPS unit a differential GPS unit could be used. Differential Global Positioning System (DGPS) is an enhancement to Global Positioning System (GPS) that uses a network of fixed ground based reference stations to broadcast the difference between the positions indicated by the satellite systems and the known fixed positions. These stations broadcast the difference between the measured satellite pseudoranges and actual (internally computed) pseudoranges, and receiver stations may correct their pseudoranges by the same amount.

a DMI (Distance Measurement Instrument). This instrument is an odometer that measures a distance traveled by the car 1 by sensing the number of rotations of one or more of the wheels 2. The DMI is also connected to the microprocessor μP to allow the microprocessor μP to take the distance as measured by the DMI into account while calculating the display signal from the output signal from the GPS unit.

an IMU (Inertial Measurement Unit). Such an IMU can be implemented as 3 gyro units arranged to measure rotational accelerations and translational accelerations along 3 orthogonal directions. The IMU is also connected to the microprocessor μP to allow the microprocessor μP to take the measurements by the DMI into account while calculating the display signal from the output signal from the GPS unit. The IMU could also comprise dead reckoning sensors.

It will be noted that one skilled in the art can find many combinations of Global Navigation Satellite systems and on-board inertial and dead reckoning systems to provide an accurate location and orientation of the vehicle and hence the equipment (which are mounted with know positions and orientations with references to the vehicle).

The system as shown in FIG. 1 is a so-called “mobile mapping system” which collects geographic data, for instance by taking pictures with one or more camera(s) 9(i) mounted on the car 1. The camera(s) are connected to the microprocessor μP. The camera(s) 9(i) in front of the car could be a stereoscopic camera. The camera(s) could be arranged to generate an image sequence wherein the images have been captured with a predefined frame rate. In an exemplary embodiment one or more of the camera(s) are still picture cameras arranged to capture a picture every predefined displacement of the car 1 or every interval of time. The predefined displacement is chosen such that a location at a predefined distance perpendicular to the driving direction is captured be at least two subsequent pictures of a side looking camera. For example a picture could be captured after each 4 meters of travel, resulting in an overlap in each image of a plane parallel to the driving direction at 5 meters distance.

The laser scanner(s) 3(j) take laser samples while the car 1 is driving along buildings at the roadside. They are also connected to the microprocessor μP and send these laser samples to the microprocessor μP.

It is a general desire to provide as accurate as possible location and orientation measurement from the 3 measurement units: GPS, IMU and DMI. These location and orientation data are measured while the camera(s) 9(i) take pictures and the laser scanner(s) 3(j) take laser samples. The pictures and laser samples are stored for later use in a suitable memory of the μP in association with corresponding location and orientation data of the car 1, collected at the same time these pictures were taken. The pictures include information as to road information, such as center of road, road surface edges and road width. As the location and orientation data associated with the laser samples and pictures is obtained from the same position determination device, an exact match can be made between the pictures and laser samples.

FIG. 2 shows which position signals can be obtained from the three measurement units GPS, DMI and IMU shown in FIG. 1. FIG. 2 shows that the microprocessor μP is arranged to calculate 6 different parameters, i.e., 3 distance parameters x, y, z relative to an origin in a predetermined coordinate system and 3 angle parameters ωₓ, ω_{y}, and ω_{z}, respectively, which denote a rotation about the x-axis, y-axis and z-axis respectively. The z-direction coincides with the direction of the gravity vector. The global UTM coordinate system could be used as predetermined coordinate system.

It is a general desire to provide as accurate as possible location and orientation measurement from the 3 measurement units: GPS, IMU and DMI. These location and orientation data are measured while the camera(s) 9(i) take images and the laser scanner(s) 3(j) take laser samples. Both the images and the laser samples are stored for later use in a suitable memory of the microprocessor in association with the corresponding location and orientation data of the car 1 at the instant in time these pictures and laser samples were taken and the position and orientation of the cameras and the laser scanners relative to the car 1.

The pictures and laser samples include information as to objects at the roadside, such as building block facades. In an embodiment, the laser scanner(s) 3(j) are arranged to produce an output with minimal 50 Hz and 1 deg resolution in order to produce a dense enough output for the method. A laser scanner such as MODEL LMS291-S05 produced by SICK is capable of producing such an output.

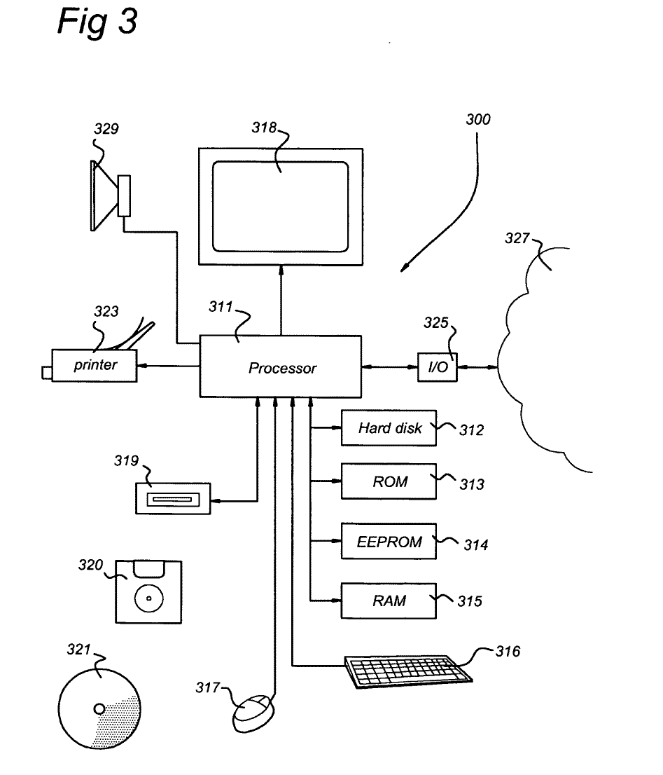

The microprocessor in the car 1 and memory 9 may be implemented as a computer arrangement. An example of such a computer arrangement is shown in FIG. 3.

In FIG. 3, an overview is given of a computer arrangement 300 comprising a processor 311 for carrying out arithmetic operations. In the embodiment shown in FIG. 1, the processor would be the microprocessor μR.

The processor 311 is connected to a plurality of memory components, including a hard disk 312, Read Only Memory (ROM) 313, Electrical Erasable Programmable Read Only Memory (EEPROM) 314, and Random Access Memory (RAM) 315. Not all of these memory types need necessarily be provided. Moreover, these memory components need not be located physically close to the processor 311 but may be located remote from the processor 311.

The processor 311 is also connected to means for inputting instructions, data etc. by a user, like a keyboard 316, and a mouse 317. Other input means, such as a touch screen, a track ball and/or a voice converter, known to persons skilled in the art may be provided too.

A reading unit 319 connected to the processor 311 is provided. The reading unit 319 is arranged to read data from and possibly write data on a removable data carrier or removable storage medium, like a floppy disk 320 or a CDROM 321. Other removable data carriers may be tapes, DVD, CD-R, DVD-R, memory sticks etc. as is known to persons skilled in the art.

The processor 311 may be connected to a printer 323 for printing output data on paper, as well as to a display 318, for instance, a monitor or LCD (liquid Crystal Display) screen, or any other type of display known to persons skilled in the art.

The processor 311 may be connected to a loudspeaker 329.

Furthermore, the processor 311 may be connected to a communication network 327, for instance, the Public Switched Telephone Network (PSTN), a Local Area Network (LAN), a Wide Area Network (WAN), the Internet etc by means of I/O means 325. The processor 311 may be arranged to communicate with other communication arrangements through the network 327. The I/O means 325 are further suitable to connect the position determining device (DMI, GPS, IMU), camera(s) 9(i) and laser scanner(s) 3(j) to the computer arrangement 300.

The data carrier 320, 321 may comprise a computer program product in the form of data and instructions arranged to provide the processor with the capacity to perform a method in accordance to the invention. However, such computer program product may, alternatively, be downloaded via the telecommunication network 327.

The processor 311 may be implemented as a stand alone system, or as a plurality of parallel operating processors each arranged to carry out subtasks of a larger computer program, or as one or more main processors with several sub-processors. Parts of the functionality of the invention may even be carried out by remote processors communicating with processor 311 through the telecommunication network 327.

The components contained in the computer system of FIG. 3 are those typically found in general purpose computer systems, and are intended to represent a broad category of such computer components that are well known in the art.

Thus, the computer system of FIG. 3 can be a personal computer, workstation, minicomputer, mainframe computer, etc. The computer can also include different bus configurations, networked platforms, multi-processor platforms, etc. Various operating systems can be used including UNIX, Solaris, Linux, Windows, Macintosh OS, and other suitable operating systems.

For post-processing the images and scans as taken by the camera(s) 9(i) and the laser scanner(s) 3(j) and position/orientation data; a similar arrangement as the one in FIG. 3 will be used, be it that that one will not be located in the car 1 but may conveniently be located in a building for off-line post-processing. The images and scans as taken by camera(s) 9(i) and scanner(s) 3(j) and associated position/orientation data are stored in one or more memories 312-315. That can be done via storing them first on a DVD, memory stick or the like, or transmitting them, possibly wirelessly, from the memory 9. The associated position and orientation data, which defines the track of the car 1 could be stored as raw data including time stamps. Furthermore, each image and laser scanner sample has a time stamp. The time stamps enables us to determine accurately the position and orientation of the camera(s) 9(i) and laser scanner(s) 3(j) at the instant of capturing an image and laser scanner sample, respectively. In this way the time stamps define the spatial relation between views shown in the images and laser scanner samples. The associated position and orientation data could also be stored as data which is linked by the used database architecture to the respective images and laser scanner samples.

In the present invention, multi viewpoint panoramas are produced by using both the images taken by the camera(s) 9(i) and the scans taken by the laser scanner(s) 3(j). The method uses a unique combination of techniques from both the field of image processing and laser scanning technology. The invention can be used to generate a multi viewpoint panorama varying from a frontage of a building to a whole roadside view of a street.

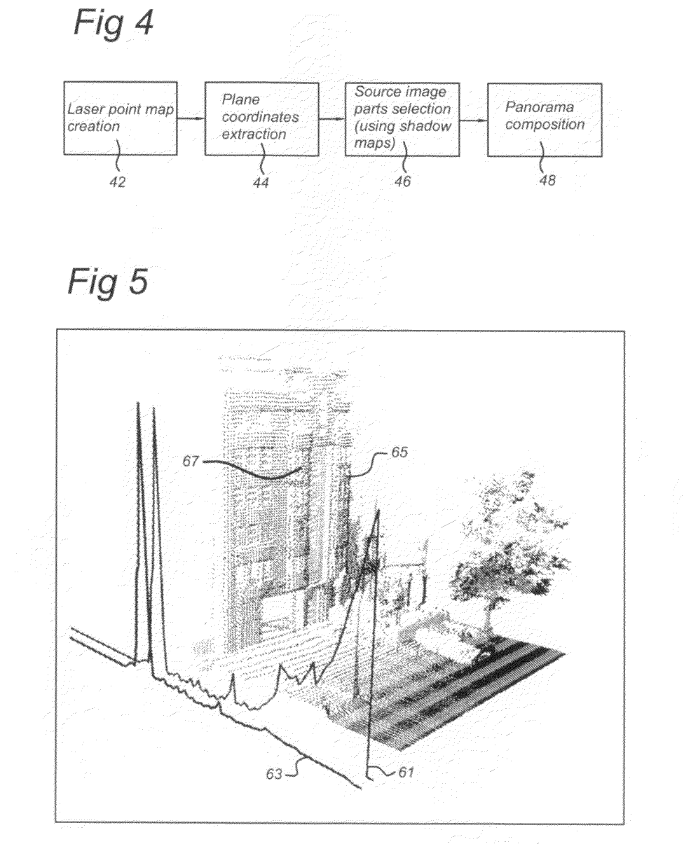

FIG. 4 shows a flow diagram of an exemplar implementation of the process for producing roadside information according to the invention. FIG. 4 shows the following actions:

A. action 42: laser point map creation

B. action 44: plane coordinates extraction of object from the laser point map

C. action 46: source image parts selection (using shadow maps)

D. action 48: panorama composition from the selected source image parts. These actions will be explained in detail below.

A. Action 42: Laser Point Map Creation

A good method for finding plane points is to use a histogram analysis. The histogram comprises a number of laser scan samples as taken by the laser scanner(s) 3(j) at a certain distance as seen in a direction perpendicular to a trajectory traveled by an MMS system and summed along a certain distance traveled by the car 1. The laser scanner(s) scan in an angular direction over, for instance, 180° in a surface perpendicular to the earth surface. E.g., the laser scanner(s) may take 180 samples each deviating by 1° from its adjacent samples. Furthermore, a slice of laser scan samples is made at least every 20 cm. With a laser scanner which rotates 75 time a second, the car should not drive faster then 54 km/h. Most of the time, the MMS system will follow a route along a line that is directed along a certain road (only when changing lanes for some reason or turning a corner the traveled path will show deviation from this).

The laser scanner(s) 3(j) are, in an embodiment 2D laser scanner(s). A 2D laser scanner 3(j) provides a triplet of data, so called a laser sample, comprising time of measurement, angle of measurement, and distance to nearest solid object that is visible at this angle from the laser scanner 3(j). By combining the car 1 position and orientation, which is captured by the position determination devices in the car, the relative position and orientation of the laser scanner with respect to the car 1 and the laser sample, a laser point map as shown in FIG. 5 is created. The laser point map shown in FIG. 5 is obtained by a laser scanner which scans in a direction perpendicular to the driving direction of the car. If more than one laser scanner is used to generate the laser point map, the laser scanners may for example have an angle of 45°, 90° and/or 135°. If using only one laser scanner, a laser scanner scanning perpendicular to the driving direction provides the best resolution in the laser point map space for finding vertical planes parallel to the driving direction.

In FIG. 5, there are shown two histograms:
1. distance histogram 61—this histogram 61 shows the number of laser scan samples as a function of distance to the car 1 as summed over a certain travel distance, e.g. 2 meter, including samples close to the car 1. When every 20 cm a laser scan slice is made, the laser scan samples of 10 slices will be taken into account. There is a peak shown close to the car 1 indicating a laser “echo” close to the car 1. This peak relates to many echo's being present close to the car 1 because of the angular sweep made by the laser scanning. Moreover, there is a second peak present at a greater distance which relates to a vertical surface of an object identified at that greater distance from the car 1.
2. distance histogram 63 showing only the second peak at a certain distance from the car 1 indicating only one object. This histogram is achieved by eliminating the higher density of laser scan samples in the direct neighbourhood of the car 1 due to the angular distribution of the laser scanning. The effect of this elimination is that one will better see objects at a certain distance away from the car 1, i.e. the façade of a building 65. The elimination has further the effect that in the histogram the influence of obstacles is reduced. Which reduces the chance that an obstacle erroneously will be recognized as a vertical plane.

The peak on histogram 63 indicates the presence of a flat solid surface parallel to the car heading. The approximate distance between the car 1 and the façade 65 can be determined by any available method. For instance, the method as explained in a co-pending patent application PCT/NL2006/050264, which is hereby incorporated by reference, can be used for that purpose. Alternatively, GPS (or other) data indicating the trajectory traveled by the car 1 and data showing locations of footprints of buildings can be compared and, thus, render such approximate distance data between the car 1 and the façade 65. By analysing the histogram data within a certain area about this approximate distance, the local maximal peak within this area is identified as being the base of a façade 65. All laser scan samples that are within a perpendicular distance of, for instance, 0.5 m before this local maximal peak are considered as architectural detail of the façade 65 and marked as “plane points”. The laser scan samples that have a perpendicular distance larger than the maximal peek are discarded or could be marked as “plane points”. All other samples, are the laser scan samples having a position between the position of the local maximum peak and the position of the car 1, are considered as “ghost points” and are marked so. It is observed that the distance of 0.5 m is only given as an example. Other distances may be used, if required.

Along the track of the car 1, a histogram analysis is performed every 2 meters. In this way the laser point map is divided in slices of 2 meters. In every slice the histogram determines whether a laser scan sample is marked “plane point” or “ghost point”.

B. Action 44: Plane Coordinates Extraction of Object from the Laser Point Map

The laser samples marked as “plane points” are used to extract plane coordinates from the laser point map. The present invention operates on a surface in a 3D space, representing a frontage (typically building facade). The present invention is elucidated by examples wherein the surface is a polygon being a vertical rectangle representing a building facade. It should be noted that the method can be applied to any ‘vertical’ surface. Therefore the term “polygon” in the description below, should not be limited to a closed plane figure bounded by straight sides, but could in principle be any ‘vertical’ surface. ‘Vertical’ surface means any common constructed surface that can be seen by the camera(s).

The polygons are extracted from the laser scanners data marked as “plane points”. Many prior art techniques are available, including methods based on the RANSAC (Random Sample Consensus) algorithm, to find planes or surfaces.

The straightforward RANSAC algorithm is used directly on the 3D points marked as “plane points”. For only vertical planes a simplified embodiment of the invention first all non-ground points are projected on some horizontal plane by discarding the height value of a 3D point. Then lines are detected using RANSAC or Hugh transform on the 2D points of said horizontal plane. These lines are used to derive the lower and upper position of the plane along the lines.

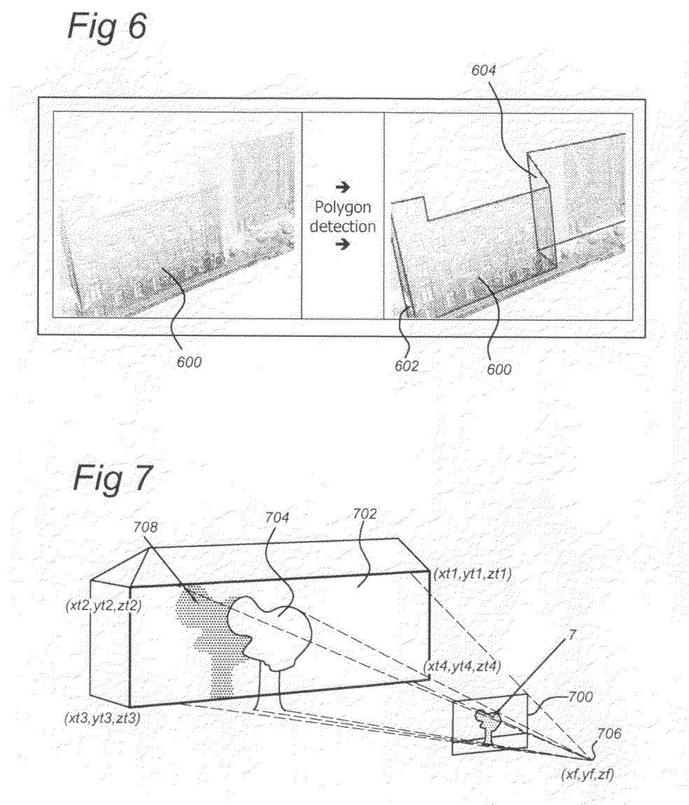

The algorithms described above require additional processing for finding plane limiting polygons. There are known prior art methods for finding the plane limiting polygons. In an example, all laser points that are below a given threshold from the plane are projected on a plane. This plane is similar to an 2D image on which clustering techniques and image segmentation algorithms can be applied to obtain the polygon representing the boundary of for example a building façade. FIG. 6 shows a exemplar result of polygon detection. The laser scanner map shown is FIG. 6 is obtained by combining the laser scanner samples from two laser scanners. One having an angle of 45° with the driving direction of the car 1 and the other having an angle of 135° with the driving direction of the car 1. Therefore, it is possible to extract next to the polygon of the plane of the front façade 600 of a building, the two polygons of the plane of the side facades 602, 604. For each detected plane, the polygon is described by plane coordinates which are the 3D positions of the corners of the plane in the predetermined coordinate system.

It should be noted that also geo-referenced 3D positions about buildings, which could be obtained from commercial databases, could be used to retrieve the polygons of planes and to determine whether a laser scanner sample from the laser scanner map is a “plane point” or a “ghost point”.

It should be noted that when a multi viewpoint panorama is generated for a frontage of only one building the orientation of the base of the frontage may not necessarily be parallel to the driving direction.

The multi viewpoint panoramas of frontages can be used to generate a roadside multi view point panorama. A roadside panorama is a composition of a plurality of multi viewpoint panoramas of buildings. Characteristics of a roadside panorama according to the invention are:
the panorama represents a virtual common constructed vertical surface;
each column of pixels of the panorama represents the vertical surface at a predefined perpendicular distance from the track of the car, center line of the street or any other representation of a line along the street, and
each pixel of the panorama represents an area of the surface, wherein the area has a fixed height.

In case a roadside panorama of a street is generated, the surface of the panorama is generally regarded to be parallel to the driving direction, centerline or any other feature of a road extending along the road. Accordingly, the surface of a roadside panorama of a curved street will follow the curvature of the street. Each point of the panorama is regarded to be seen as perpendicular to the orientation of the surface. Therefore, for a roadside panorama of a street, the distance up to the most common surface is searched for in the laser scanner map or has been given a predefined value. This distance defines the resolution of the pixels of the panorama in horizontal and vertical directions. The vertical resolution depends on the distance, whereas the horizontal resolution depends on a combination of the distance and the curvature of the line along the street. However, the perpendicular distance between the driving direction of the car and the base of the vertical surface found by the histogram analysis may comprise discontinuities. This could happen when two neighboring buildings do not have the same building line (i.e. do not line up on the same plane). To obtain a roadside panorama defined above, the multi viewpoint panorama of each building surface will be transformed to a multi viewpoint panorama as if the building surface has been seen from the distance up to the most common surface. In this way, every pixel will represent an area having equivalent height.

In the known panoramas, two objects having the same size but at different distances will be shown in the panorama with different sizes. According to an embodiment of the invention, a roadside panorama will be generated wherein two similar objects having different perpendicular distances with respect to the driving direction will have the same size in the multi viewpoint panorama. Therefore, when generating the roadside panorama, the panorama of each facade will be scaled such that each pixel of the roadside panorama will have the same resolution. Consequently, in a roadside panorama generated by the method described above, a building having a real height of 10 meters at 5 meter distance will have the same height in the roadside panorama as a building having a real height of 10 meters at 10 meter distance.

A roadside panorama with the characteristics described above, shows the facades of buildings along the street, as buildings having the same building line, whereas in reality they will not have the same building line. The important visual objects of the panorama are in the same plane. This enables us to transform without annoying visual deformation the front view panorama into a perspective view. This has the advantage that the panorama can be used in applications running on a system as shown in FIG. 3 or any kind of mobile device, such as a navigation device, with minimal image processing power. By means of the panorama, wherein the facades of buildings parallel to the direction of a street are scaled to have the same building line, a near-realistic view of the panorama can be presented from any viewing angle. A near-realistic view is an easy to interpretative view that could represent the reality but that does not correspond to the reality.

C. Action 46: Source Image Parts Selection (using Shadow Maps)

A multi-viewpoint panorama obtained by the present invention is composed from a set of images from image sequence(s) obtained by camera(s) 9(i). Each image has associated position and orientation data. The method described in unpublished patent application PCT/NL2006/050252 is used to determine which source images have viewing windows which include at least a part of a surface determined in action 44. First, from at least one source image sequence produced by the cameras, the source images having a viewing window which includes at least a part of the surface for which a panorama has to be generated, are selected. This could be done as each source image has associated position and orientation of the camera capturing said source image.

In the present invention, a surface corresponds to mainly vertical planes. By knowing the position and orientation of the camera together with the viewing angle and viewing window, the projection of the viewing window on the surface can be determined. A person skilled in the art knowing the math of goniometry is able to rewrite the orthorectification method described in the unpublished application PCT/NL2006/050252, into a method for projecting a viewing window having an arbitrary viewing angle on an arbitrary surface. The projection of a polygon or surface area on a viewing window of a camera with both an arbitrary position and orientation is performed by three operations: rotation over focal point of camera, scaling and translation.

FIG. 7 shows a perspective view of the projection of a source image 700, which is equivalent to the viewing window of a camera on a virtual surface 702. The virtual surface 702 corresponds to a polygon and has the coordinates (xt1, yt1, zt1), (xt2, yt2, zt2), (xt3, yt3, zt3) and (xt4, yt4, zt4). Reference 706 indicates the focal point of the camera. The focal point 706 of the camera has the coordinates (xf, yf, zf). The border of the source image 700 defines the viewing window of the camera. The crossings of a straight line through the focal point 706 of the camera through both the viewing window and the virtual surface 702 define the projection from a pixel of the virtual surface 702 on a pixel of the source image 700. Furthermore, the crossing with the virtual surface 702 of a straight line through the focal point 706 of the camera and a laser scanner sample marked as “ghost points” defines a point of the virtual plane that cannot be seen in the viewing window. In this way, a shadow 708 of an obstacle 704 can be projected on the virtual surface 702. A shadow of an obstacle is a contiguous set of pixels in front the virtual surface, e.g. a façade. As the position of the virtual surface corresponds to the position of a frontage, the shadow can be projected on the virtual surface accurately. It should be noted that balconies which extend up to 0.5 meter from the frontage are regarded to be part of the common constructed surface. Consequently, details of the perspective view of said balconies in the source image will be projected on the multi viewpoint panorama. Details of the perspective view are sides of the balconies perpendicular to the frontage, which will not be visualized in a pure front view image of a building.

The above projection method is used to selects source images viewing at least a part of the surface. After selection of a source image viewing at least a part of the surface, in the laser scanner map the laser scanner samples having a position between the position of the focal point of the camera and the position of the surface are selected. These are the laser scanner samples which are marked as “ghost point” samples. The selected laser scan samples represent obstacles that hinder the camera to record the object represented by the virtual surface 702. The selected laser scanner samples are clustered by known algorithms to form one or more solid obstacles. Then a shadow of said obstacles is generated on the virtual surface 702. This is done by extending a straight line through the focal point 706 and the solid obstacle up to the position of the virtual surface 702. The position where a line along the boundary of the obstacle hits the virtual surface 702 corresponds to a boundary point of the shadow of the obstacle.

From FIG. 7 it can be seen that an object 704, i.e. a tree, in front of the surface 702 is seen in the image. If the position of the object 704 with respect the virtual surface 702 and focal point 706 of the camera is known, the shadow 708 of the object 704 on the virtual surface 702 can easily be determined.

According to the invention the surface retrieved from the laser scanner map or 3D information about building façades from commercial databases, are used to create geo-positioned multi-viewpoint panoramas of said surface. The method according to the invention combines the 3D information of the camera 9(i) position and orientation, the focal length and resolution (=pixel size) of an image, the 3D information of a detected plane and 3D positions of the ghost point samples of the laser scanner map. The combination of position and orientation information of the camera and the laser scanner map enables the method to determine for each individual image:

1) whether a source image captured by the camera includes at least a part of the surface; and

2) which object is hindering the camera to visualize the image information that would be at said part of the surface.

The result of the combination enables the method to determine on which parts of the images a façade represented by the virtual plane is visible. Thus which images could be used to generate the multi viewpoint panorama. An image having a viewing window that could have captured at least a part of the virtual surface but could not capture any part of the virtual surface due to an huge obstacle in front of the camera, will be discarded. The “ghost points” between the location of the surface and the camera position are projected on the source image. This enables the method to find surfaces or areas (shadow zones) where the obstacle is visible on the source image(s) and hence the final multi-viewpoint panorama.

It should be noted that examples to elucidate the invention uses a polygon as virtual surface. Simple examples have been used to reduce the complexity of the examples. However, a person skilled in the art would immediately recognize that the invention is not limited to flat surfaces but could be used for any smooth surface, for example a vertical curved surface.

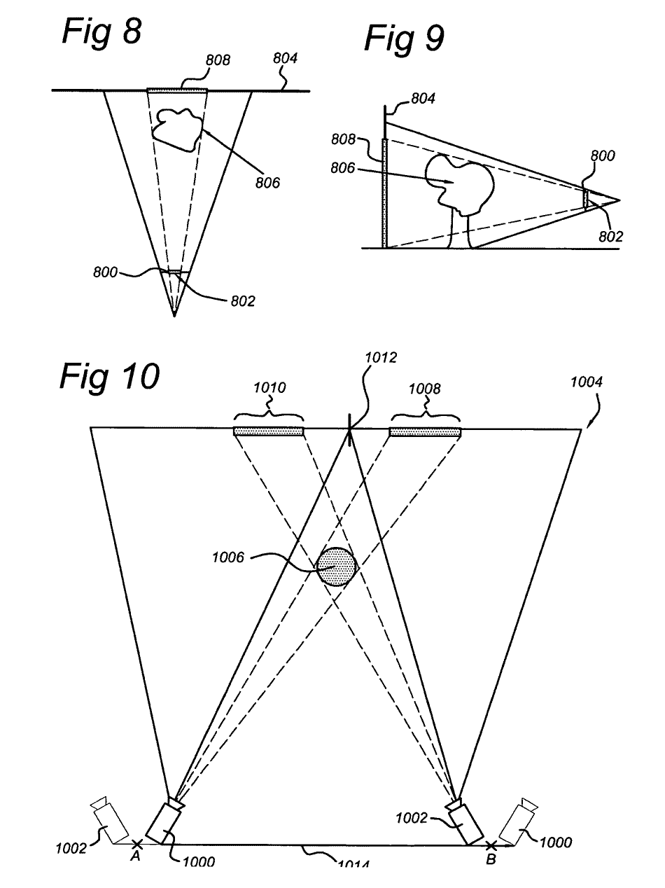

FIGS. 8 and 9 show a top view and side view, respectively, of projecting an obstacle 806 on a source image 800 and a virtual surface 804. The position of the obstacle 806 is obtained from the laser scanner map. Thus according to the invention the position of objects is not obtained by complex image processing algorithms which uses image segmentation and triangulation algorithms on more than one image to detect and determine positions of planes and obstacles in images, but by using the 3D information from the laser scanner map in combination with the position and orientation data of the camera. Using the laser scanner map in combination with the position and orientation data of a camera provides a simple and accurate method to determine in an image the position of obstacles which hinder the camera to visualize the area of a surface of an object behind said obstacle. Goniometry is used to determine the position of the shadow 802 of the obstacle 806 on the source image 800 as well as the shadow 808 of the obstacle 806 on the virtual surface 804 which describes the position and orientation of the frontage of an object, i.e. a building facade. A shadow 808 on the virtual surface will be called shadow zone in the following description of the invention.

A multi viewpoint panorama is composed by finding the areas of the source images which visualize in the best way the surface that has been found in the laser scanner map and projecting said areas on the multi viewpoint panorama. The areas of the source images that do not visualize obstacles or visualize an obstacle with the smallest shadow (=area) on the multi viewpoint panorama should be selected and combined to obtain the multi viewpoint panorama.

Two possible implementations will be disclosed for finding the parts of the source images to generate the multi viewpoint panorama.

### First Embodiment for Finding the Areas

The above objective has been achieved in the first embodiment by generating a shadow map for each source image that visualizes a part of the surface. A shadow map is a binary image, wherein the size of the image corresponds to the area of the source image that visualizes the plane when projected on the plane and wherein for each pixel is indicated whether it visualizes in the source image the surface or an obstacle. Subsequently, all shadow maps are superposed on a master shadow map corresponding to the surface. In this way one master shadow map is made for the surface and thus for the multi viewpoint panorama to be generated.

In an embodiment, a master shadow map is generated wherein a shadow zone in this master shadow map indicates that at least one of the selected source images visualizes an obstacle when the area of the at least one selected source image corresponding to the shadow zone is projected on the multi viewpoint panorama. In other words, this master shadow map identifies which areas of a façade are not obstructed by any obstacle in the images. It should be noted that the size and resolution of the master shadow map is similar to the size and resolution of the multi viewpoint panorama to be produced.

The master shadow map is used to split the multi view point panorama into segments. The segments are obtained by finding the best “sawing paths” to cut the master shadow map into said segments, wherein the paths on the master shadow map are not dividing a shadow zone in two parts. The segmentation defines how the panorama has to be composed. It should be noted that a sawing path is always across an area of the master shadow map that has been obtained by superposition of the shadow maps of at least two images. Having the paths between the shadow zones ensures that the seams between the segments in the panorama are in the visual parts of a façade and not possibly in an area of an obstacle that will be projected on the façade. This enables the method to select the best image for projecting an area corresponding to a segment on the panorama. The best image could be the image having no shadow zones in the area corresponding to the segment or the image having the smallest shadow zone area. An additional criterion to determine the best position of the “sawing path” may be the looking angles of the at least two images with respect to the orientation of the plane of the panorama to be generated. As the at least two images have different positions, the looking angle with respect to the façade will differ. It has been found that the most perpendicular image will provide the best visual quality in the panorama.

Each segment can be defined as a polygon, wherein the edges of a polygon are defined by a 3D position in the predefined coordinate system. As the “sawing paths” are across pixels which visualize in all of the at least two source images the surface corresponding to the plane, this allows the method to create a smoothing zone between two segments. The smoothing reduces visual disturbances in the multi viewpoint panorama. This aspect of the invention will be elucidated later on. The width of the smoothing zone could be used as a further criterion for finding the best “sawing paths”. The width of the smoothing zone could be used to define the minimal distance between a sawing path and a shadow zone. If the nearest distance between the borderline of the two shadow zones is smaller than a predefined distance, a segment will be created with two shadow zones. Furthermore, the pixels of the source images for the smoothing zone should not represent obstacles. The pixels for the smoothing zone are a border of pixels around the shadows. Therefore the width of the smoothing zone defines the minimal distance between the borderlines of a shadow zone and the polygon defining the segment which encompasses said shadow zone. It should be noted that the distance between the borderline of a shadow zone and the polygon defining the segment could be zero if the obstacle causing the shadow zone is partially visible in an image.

A multi viewpoint panorama is generated by combining the parts of the source images associated with the segments. To obtain the best visualization of a multi viewpoint panorama, for each segment, one has to select the source image which visualizes in the most appropriate way said segment of the object for which a multi viewpoint panorama has to be generated.

Which area of a source image that has to be used to produce the corresponding segment of the panorama is determined in the following way:

1. select the source images having an area which visualize the whole area of a segment;

2. select from the source images in the previous action the source image that comprises the least number of pixels marked as shadow in the associated segment in the shadow map associated with said source image.

The first action ensures that the pixels of source images corresponding to a segment are taken from only one source image. This reduces the number of visible disturbances such as visualizing partially an obstacle. For example, a car parked in front of an area of a building corresponding to a segment that can be seen in three images, one visualizing the front end, one visualizing the back end and one visualizing the whole car, in that case the segment from the image visualizing the whole car will be taken. It should be noted, that choosing other images could result in a panorama visualizing more details of the object to be represented by the panorama that are hidden behind the car in the selected image. It has been found that a human finds an image which completely visualizes an obstacle more attractive than an image which visualized an said obstacle partially. It should further be noted that there could be an image that visualizes the whole area without a car, however with a less favorable viewing angle than the other three images. In that case this image will be chosen as it comprises the least number (zero) of pixels marked as shadow in the associated segment in the shadow map associated with said image.

Furthermore, when there are two ore images which visualize the whole area without any object (=zero pixels marked as shadow), the image that has the nearest perpendicular viewing angle will be chosen for visualizing the area in the multi viewpoint panorama.

The second action after the first action ensures that the source image is selected which visualizes the most of the object represented by the panorama. Thus for each segment the source image is selected which visualizes the smallest shadow zone area in the area corresponding to said segment.

If there isn't any image visualizing the whole area corresponding to a segment, the segment has to be sawed in sub-segments. In that case the image boundaries can be used as sawing paths. The previous steps will be repeated on the sub-segments to select the image having the most favorable area for visualizing the area in the multi viewpoint panorama. Parameters to determine the most favorable area are the number of pixels marked as shadow and the viewing angle.

In other words source images for the multi viewpoint panorama are combined in the following way:

1. When the shadow zones in the master shadow map are disjoint, the splice is performed in the part of the multi viewpoint panorama laying between shadow zones defined by the master shadow map;

2. When shadow zones of the obstacles visible in the selected source images projected on the multi viewpoint panorama are overlapping or not disjoint, the area of the multi viewpoint panorama is split into parts with the following rules:
a) the source image containing the full shadow zone is selected to put into the multi view point panorama. When there is more than one source image containing the full shadow zone, the source image visualizing the segment with the nearest looking angle to a vector perpendicular is selected. In other words, front view source images visualizing a segment are preferred above angle viewed source images;
b) when there isn't any image covering full shadow zone, the segment is taken from the most perpendicular parts of the source images visualizing the segment.

### Second Embodiment for Finding the Areas

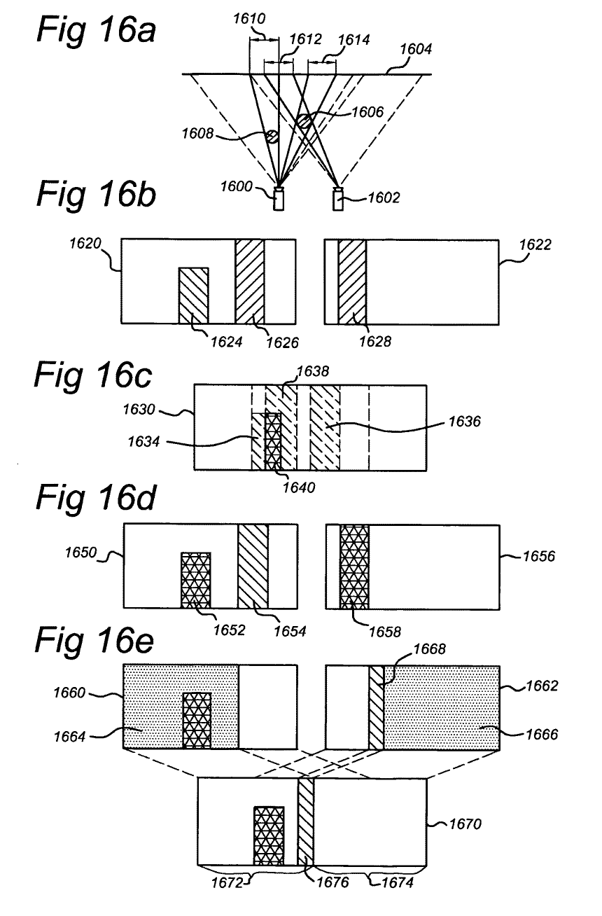

The second embodiment will be elucidated by the FIG. 16a-f. FIG. 16a shows a top view of two camera positions 1600, 1602 and a surface 1604. Between the two camera positions 1600, 1602 and the surface 1604 are located a first obstacle 1606 and a second obstacle 1608. The first obstacle 1606 can be seen in the viewing window of both camera positions and the second obstacle 1608 can only be seen by the first camera position 1600. Three (shadow) zone can be derived by projecting a shadow of the obstacles on the surface 1604. Zone 1610 is obtained by projecting a shadow of the second obstacle on the surface from the first camera position 1600. Zone 1612 and zone 1614 have been obtained by projecting a shadow of the first obstacle on the surface from the second and first camera position respectively. Shadow maps will be generated for the source images captured from the first and second camera position 1600, 1602 respectively. For each part of a source image visualizing a part of the surface 1604, a shadow map will be generated. This shadow maps, which are referenced in the same coordinate system as the multi viewpoint panorama of the surface 1604 to be generated, indicate for each pixel, whether the pixel visualizes the surface 1604 or could not visualize the surface due to an obstacle.

FIG. 16b shows the left shadow map 1620 corresponding to the source image captured from the first camera position 1600 and the right shadow map 1622 corresponding to the source image captured from the second camera position 1602. The left shadow map shows which areas of the surface 1604 visualized in the source image does not comprise visual information of the surface 1604. Area 1624 is a shadow corresponding to the second obstacle 1608 and area 1626 is a shadow corresponding to the first obstacle 1606. It can be seen that the first obstacle 1606 is taller then the second obstacle 1608. The right shadow map 1622 shows only one area 1628, which does not comprise visual information of the surface 1604. Area 1628 corresponds to a shadow of the first obstacle 1606.

The shadow maps are combined to generate a master shadow map. A master shadow map is a map associated with the surface for which a multi viewpoint panorama has to be generated. However, according to the second embodiment, for each pixel in the master shadow map is determined whether or not it can be visualized by at least one source image. The purpose of the master shadow map is to find the areas of the panorama that could not visualize the surface but will visualize an obstacle in front of the surface.

FIG. 16c shows a master shadow map 1630 that have been obtained by combining the shadow maps 1620 and 1622. This combination can be accurately made because the position and orientation of each camera is accurately recorded. Area 1640 is an area of the surface 1604 that cannot be visualized by either the source image captured from the first camera position 1600 or the second camera position 1602. The pixels of this area 1640 are critical as they will always show an obstacle and never the surface 1604. The pixels in area 1640 obtain a corresponding value, e.g. “critical”. Area 1640 will show in the multi viewpoint panorama of the surface 1604 a part of the first obstacle 1606 or a part of the second obstacle 1608. Each of the other pixels will obtain a value indicating that a value of the associated pixel of the multi viewpoint panorama can be obtained from at least one source image to visualize the surface. In FIG. 16c, the areas 1634, 1636 and 1638 indicate the areas corresponding to the areas 1624, 1626 and 1628 in the shadow maps of the respective source images. Said areas 1634, 1636 and 1638 obtain a value indicating that a value of the associated pixel of the multi viewpoint panorama can be obtained from at least one source image to visualize the surface.

The master shadow map 1630 is subsequently used to generate for each source image a usage map. A usage map has a size equivalent to the shadow map of said source image. The usage map indicates for each pixel:

1) whether the value of the corresponding pixel(s) in the source image should be used to generate the multi viewpoint panorama,

2) whether the value of the corresponding pixel(s) in the source image should not be used to generate the multi viewpoint panorama, and

3) whether the value of the corresponding pixels(s) in the source image could be used to generate the multi viewpoint panorama.

This map can be generated by verifying for each shadow zone in the shadow map of a source image whether the corresponding area in the master shadow map comprises at least one pixel indicating that the pixel can not visualize by any of the source image the surface 1604 in the multi viewpoint panorama. If so, the area corresponding to the whole shadow zone will be marked “should be used”. If not, the area corresponding to the whole shadow will be marked “should not be used”. The remaining pixels will be marked “could be used”. FIG. 16d shows the left usage map 1650 that has been obtained by combining the information in the shadow map 1620 and the master shadow map 1630. Area 1652 corresponds to the shadow of the second obstacle 1608. This area 1652 has obtained the value “should be used” as the area 1624 in the shadow map 1620 has one or more corresponding pixels in the master shadow map marked “critical”. This means that if one pixel of the area 1652 has to be used to generate the multi viewpoint panorama, all the other pixels of said area have to be used. Area 1654 corresponds to the shadow of the first obstacle 1606. Said area 1654 has obtained the value “should not be used” as the area 1626 in the corresponding shadow map 1620 does not have any pixel in the corresponding area 1636 in the master shadow map marked “critical”, this means that the first obstacle 1606 can be removed from the multi viewpoint panorama by choosing the corresponding area in the source image captured by the second camera 1602. Therefore, the area in the source image corresponding to area 1654 should not be used to generate the multi viewpoint panorama of surface 1604. The right usage map 1656 of FIG. 16d has been obtained by combining the information in the shadow map 1622 and the master shadow map 1630. Area 1658 corresponds to the shadow of the second obstacle 1606. This area 1658 has obtained the value “should be used” as the area 1628 in the shadow map 1622 has one or more corresponding pixels in the master shadow map marked “critical”. This means that if one pixel of the area 1658 has to be used to generate the multi viewpoint panorama, all the other pixels of said area have to be used.

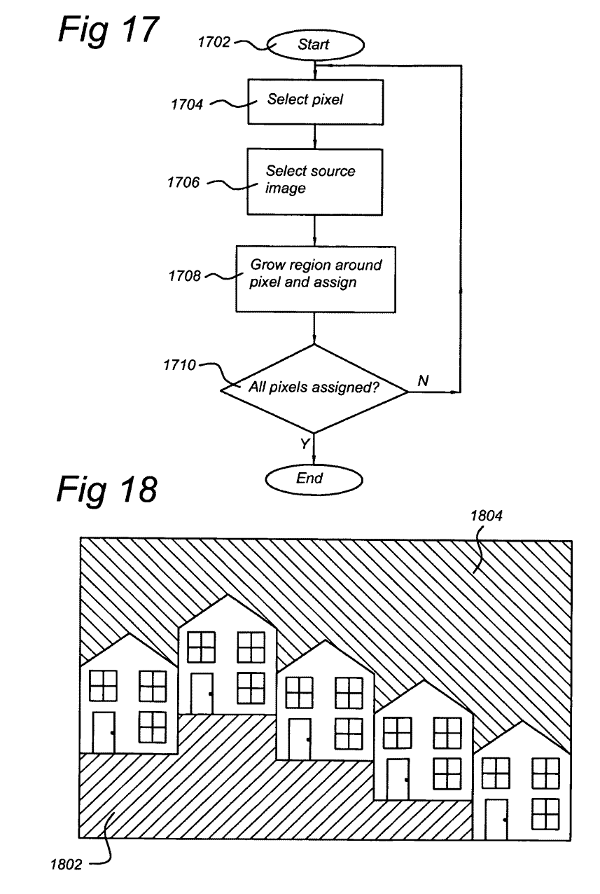

The maps 1650 and 1656 are used to select which parts of the source images have to be used to generate the multi viewpoint panorama. One embodiment of an algorithm to assign the parts of the source images to be selected will be given. It should be clear to the skilled person that may other possible algorithms can be used. A flow chart of the algorithm is shown in FIG. 17. The algorithm starts with retrieving an empty selection map indicating for each pixel of the multi viewpoint panorama which source image should be used to generate the multi viewpoint panorama of the surface 1604 and the usage maps 1650, 1656 associated with each source image.

Subsequently a pixel of the selection map is selected 1704 to which no source image has been assigned. In action 1706, a source image is searched which has in its associated usage map a corresponding pixel marked as “should be used” or “could be used”. Preferably, if the corresponding pixel in all usage maps is marked as “could be used”, the source image having the most perpendicular viewing angle with respect to the pixel is selected. Furthermore, to optimize the visibility of the surface 1604 in the panorama, in the case the corresponding pixel in one of the usage maps is marked “must be used”, by means of the master shadow map, preferably, the source image having the smallest area in the usage map marked “must be used” which covers the area marked “critical” in the master shadow map is selected.

After selecting the source image, in action 1708 the usage map of the selected image is used to determine which area of the source around the selected pixel should be used to generated the panorama. This can be done by a growing algorithm. For example, by selecting all neighboring pixels in the usage map marked “should be used” and could be used, and wherein no source image has been assigned to the corresponding pixel in the selection map.

Next action 1710 determines whether to all pixels a source image has been assigned. If not, again action 1704 is performed by selecting a pixel to which no source image has been assigned and the subsequent actions will be repeated until to each pixel a source image will be assigned.

FIG. 16e shows two images identifying which parts of the source images are selected for generating a multi viewpoint panorama for surface 1604. The combination of the parts is shown in FIG. 16f, which corresponds to the selection map 1670 of the multi viewpoint panorama for surface 1604. The left image 1660 of FIG. 16e corresponds to the source image captured by the first camera 1600 and the right image 1662 corresponds to the source image captured by the second camera 1602. The pixels in the left segment 1672 of the selection map 1670 are assigned to the corresponding area in the source image captured from the first camera position 1600, this area corresponds to area 1664 in the left image 1660 of FIG. 16e. The pixels in the right segment 1674 of the selection map 1670 are assigned to the corresponding area in the source image captured from the second camera position 1602. This area corresponds to area 1666 in the right image 1662 of FIG. 16e.

When applying the algorithm described above, a pixel was selected at the left part of the selection map, e.g. upper left pixel. Said pixel is only present in one source image. In action 1708, the neighboring area could grow till it was bounded by the border of the selection map and the pixels marked “not to be used”. In this way area 1664 is selected and in the selection map 1670, to the pixels of segment 1672, the first source image is assigned. Subsequently, a new pixel to which no source image has been assigned, is selected. This pixel is positioned in area 1666. Subsequently, the neighboring area of said pixel is selected. The borders of the area 1666 are defined by the source image borders and the already assigned pixels in the selection map 1670 to other source images, i.e. assigned to the image captured by the first camera.

The selection of pixels from the source images corresponding to the segments 1672 and 1674 would result in a multi viewpoint panorama wherein the first obstacle 1606 is not visible and the second obstacle is fully visible.

In the right image of FIG. 16e, area 1668 identifies an area which corresponding pixels could be used to generated the multi viewpoint panorama of surface 1604. This area could be obtained by extending action 1708 with the criterion that the growing process stops when the width of an overlapping border with other source images exceeds a predefined threshold value, e.g. 7 pixels, or at pixels marked as “should use” or “should not use” in the usage map. Area 1668 is such an overlapping border. This is illustrated in FIG. 16e by area 1676. This area can be used as smoothing zone. This enables the method to mask irregularities between two neighboring source images, e.g. difference in color between images. In this way the color can change smoothly from a background color of the first image to a background color of the second color. This reduces the number of abrupt color changes in area that normally should have the same color.

The two embodiments for selecting source image parts describe above generate a map for the multi viewpoint panorama wherein each pixel is assigned to a source image. This means that all information visible in the multi viewpoint panorama will be obtained by projecting corresponding source image parts on the multi viewpoint panorama. Both embodiment try to eliminate as much as possible obstacles, by choosing the parts of the source images which visualize the surface instead of the obstacle. Some parts of the surface are not visualized in any source image and thus an obstacle or part of an obstacle will be visualized if only a projection of pixels of source image parts on the panorama is applied. However, the two embodiments can be adapted to derive first a feature of the areas of the surface which cannot be seen from any of the source images. These areas correspond to the shadows in the master shadow map of the second embodiment. Some features that could be derived are height, width, shape, size. If the feature of an area matches a predefined criterion, the pixels in the multi viewpoint panorama corresponding to said area could be derived from the pixels in the multi viewpoint panorama surrounding the area. For example, if the width of the area does not exceed a predetermined number of pixels in the multi viewpoint panorama, e.g. the shadow of a lamppost, the pixel values can be obtained by assigning the average value of neighboring pixels or interpolation. It should be clear that other threshold functions may be applied.

Furthermore, an algorithm could be applied which decides whether the resulting obstacle is significant enough to be reproduced with some fidelity. For example, a tree blocking the facade is shown in two images, in one image only a small part is seen at the border of the image and in the other image the whole tree is seen. The algorithm could be arranged to determine whether including the small part in the panorama would not look stupid. If so, the small part is shown, resulting in a panorama visualizing the greatest part of the facade and a small visual irregularity due to the tree. If not, the whole tree will be included, resulting in a panorama which discloses a smaller part of the facade, but no visual irregularity with respect to the tree. In these ways, the number of visible obstacles and corresponding size in the multi viewpoint panorama can be further reduced. This enables the method to provide a panorama with the best visual effect. The functions can be performed on the respective shadow maps.

D. Action 48: Panorama Composition from the Selected Source Image Parts.

After generating a segmented map corresponding to the multi viewpoint panorama and selecting for each segment the source image that should be used to project the area corresponding to said segment in the source image, the areas in the source images associated with the segments are projected on the panorama. This process is comparable to the orthorectification method described in unpublished patent application PCT/NL2006/050252, which can be described as performing three operations on the areas of the source images, namely rotation over focal point of camera, scaling and translation, all commonly known algorithms in image processing. All the segments form together a mosaic which is a multi viewpoint panorama as images are used having different positions (=viewpoints).

Visual irregularities at the crossings from one segment to another segment can be reduced or eliminate by defining a smoothing zone along the boundary of two segments.

In an embodiment, the values of the pixels of the smoothing zone are obtained by averaging the values of the corresponding pixels in the first and second source image. In another embodiment the pixel value is obtained by the formula:

valueₚₐₙ=α×value_{image1}+(1−α)×value_{image2}

wherein, valueₚₐₙ, value_{image1} and value_{image2} are the pixel values in the multi viewpoint panorama, the first image and second image respectively and a is a value in the range 0 to 1, wherein α=1 where the smoothing zone touches the first image and α=0 where the smoothing zone touches the second image. a could change linearly from one side of the smoothing zone to the other side. In that case valueₚₐₙ is the average of the values of the first and second image in the middle of the smoothing zone, which is normally the place of splicing. It should be noted that parameter a may have any other suitable course when varying from 0 to 1.

In the technical field of image processing many other algorithms are known to obtain a smooth crossing from one segment to another segment.

The method described above will be elucidated by some simple examples.

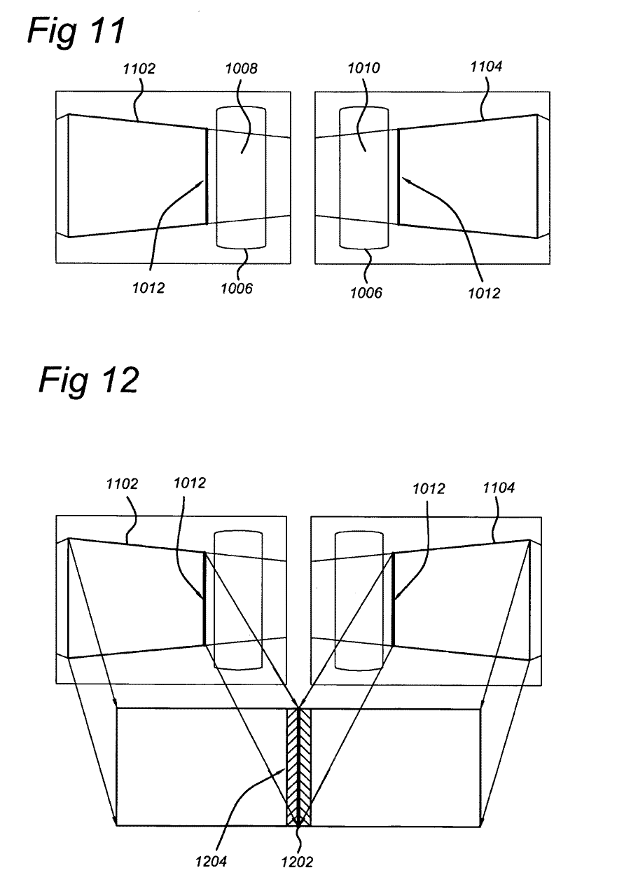

FIG. 10 shows a top view of two cameras 1000, 1002 on different positions A, B and recording the same plane 1004. The two cameras 1000, 1002 are mounted on a moving vehicle (not shown) and the vehicle is moved from position A to position B. Arrow 1014 indicates the driving direction. In the given example, the sequences of source images include only two source images that visualize plane 1004. One source image is obtained from the first camera 1000, at the instant the vehicle is at position A. The other source image is obtained from the second camera 1002, at the instant the vehicle is at position B. FIG. 11 shows the perspective view images from the situation shown in FIG. 10. The left and right perspective view images correspond to the source images captured by the first 1000 and second camera 1002, respectively. Both cameras have a different looking angle with respect to the driving direction of the vehicle. FIG. 10 shows an obstacle 1006, for example a column, positioned between the position A and B and the plane 1004. Thus a part 1008 of the plane 1004 is not visible in the source image captured by the first camera 1000 and a part 1010 of the plane 1004 is not visible in the source image captured by the source image captured by the second camera 1002.

The shadow map associated with the source image captured with camera 1000 has a shadow at the right half and the shadow map associated with the source image captured with camera 1000 has a shadow at the left half. FIG. 10 shows a top view of the master shadow map of the plane 1004. The shadow map comprises two disjoint shadows 1008 and 1010. According to the invention the place 1012 of splicing the master shadow map is between the two shadows 1008 and 1010. In FIG. 11, the polygons 1102 and 1104 represent the two segments in which the plane 1004 is divided.

As described above, the method according the invention analyses for each segment the corresponding area in the shadow map of each source image. The source image visualizing the segment with the smallest shadow area will be selected. In the given example the source image comprising no shadows in the corresponding segment will be selected to represent said segment. Thus, the left part of the plane 1004, indicated by polygon 1102 in FIG. 11 will be obtained from the image captured by the first camera 1000 and the right part of plane 1004, indicated by polygon 1104 in FIG. 11 will be obtained from the image captured by the first camera 1002.

FIG. 12 illustrates the process of composing a panorama for plane 1004 in FIG. 10 from the two images shown in FIG. 11 after selection for each segment the corresponding source image to visualize the corresponding segment. In an embodiment the segments defined by polygons 1102 and 1104 are projected on the multi viewpoint panorama for plane 1004.

The two segments could not be perfectly matched at the place of splicing 1202. Reasons for this could be the difference in resolution, colors, and other visual parameters of the two source images at the place of splicing 1202. A user could notice said irregularities in the panorama when the pixels values of the two segments at both sides of the place of spicing 1202 are directly derived from only one of the respective images. To reduce the visibility of said defects, a smoothing zone 1204 around the place of splicing 1202 can be defined.

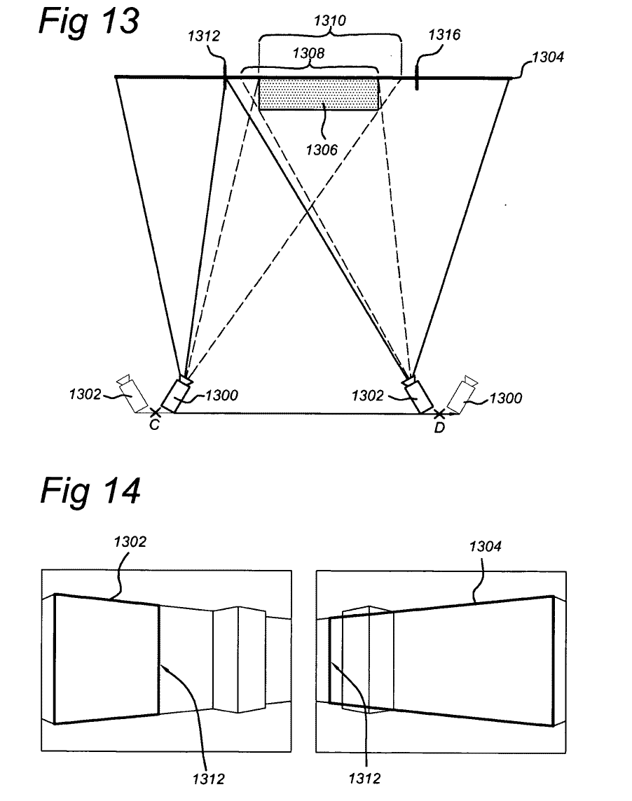

FIGS. 13 and 14 show another simple example similar to the example give above for elucidating the invention. In this example another obstacle obstructs to visualize plane 1304. FIG. 13 shows a top view of two cameras 1300, 1302 on different positions C, D and recording the same plane 1304. The two cameras 1300, 1302 are mounted on a moving vehicle (not shown) and the vehicle is moved from position C to position D. Arrow 1314 indicates the driving direction. In the given example, the sequences of source images include only two source images that visualize plane 1304. One source image is obtained from the first camera 1300, at the instant the vehicle is at position C. The other source image is obtained from the second camera 1302, at the instant the vehicle is at position D. FIG. 14 shows the perspective view images from the situation shown in FIG. 13. The left and right perspective view images shown in FIG. 14 correspond to the source images captured by the first 1300 and second camera 1302, respectively. Both cameras have a different looking angle with respect to the driving direction of the vehicle. FIG. 13 shows an obstacle 1306, for example a column, positioned between the position C and D and the plane 1004. Thus a part 1308 of the plane 1304 is not visible in the source image captured by the first camera 1300 and a part 1310 of the plane 1304 is not visible in the source image captured by the source image captured by the second camera 1302.

FIG. 13 shows a top view of the master shadow map associated with the plane 1304. The master shadow map shows that shadows 1008 and 1010 have an overlapping area. As there are only two images visualizing plane 1304, the area of the plane associated with the shadow corresponding to the overlap cannot be seen in any of the images. Thus, the area corresponding to the overlap in the panorama of the plane 1304 will visualize the corresponding part of the obstacle 1306. Now, the master shadow map could be divided in three parts, wherein one part comprises the shadow. The borderline of the polygon defining the segment comprising the shadow is preferably spaced at a minimum distance from the borderline of the shadow. This allows us to define a smoothing zone. References 1312 and 1316 indicate the left and right borderline of the segment. As both source images visualize fully the segment, what can easily be seen in FIG. 14, the segment will be taken from the source image having the most perpendicular looking angle with respect to the plane. In the given example the segment will be taken from the source image taken by the second camera 1302. As the segment comprising the obstacle and the most right part of the plane will be taken from the same source image to project said segments on the panorama, the borderline with reference 1316 can be removed and no smoothing zone has to be defined there. Thus finally two segments remain to compose the panorama of plane 1304. In FIG. 14, the polygons 1302 and 1304 represent the two segments of the source images which are used to compose the plane 1304. Reference 1312 indicate the borderline where a smoothing zone could be defined.

The method described above is performed automatically. It might happen that the quality of the multi viewpoint panorama is such that the image processing tools and object recognition tools performing the invention need some correction. For example the polygon found in the laser scanner map corresponds to two adjacent buildings whereas for each building façade a panorama has to be generated. In that case the method includes some verification and manual adaptation actions to enable the possibility to confirm or adapt intermediate results. These actions could also be suitable for accepting intermediate results or the final result of the road information generation. Furthermore, the superposition of the polygons representing building surfaces and/or the shadow map on one or more subsequent source images could be used to request a human to perform a verification.

The multi viewpoint panoramas produced by the invention are stored in a database together with associated position and orientation data in a suitable coordinate system. The panoramas could be used to map out pseudo-realistic, easy to interpret and produce views of cities around the world in applications as Google Earth, Google Street View and Microsoft's Virtual Earth or could be conveniently stored or served up on navigation devices.

As described above the multi viewpoint panoramas are used to generated roadside panoramas.

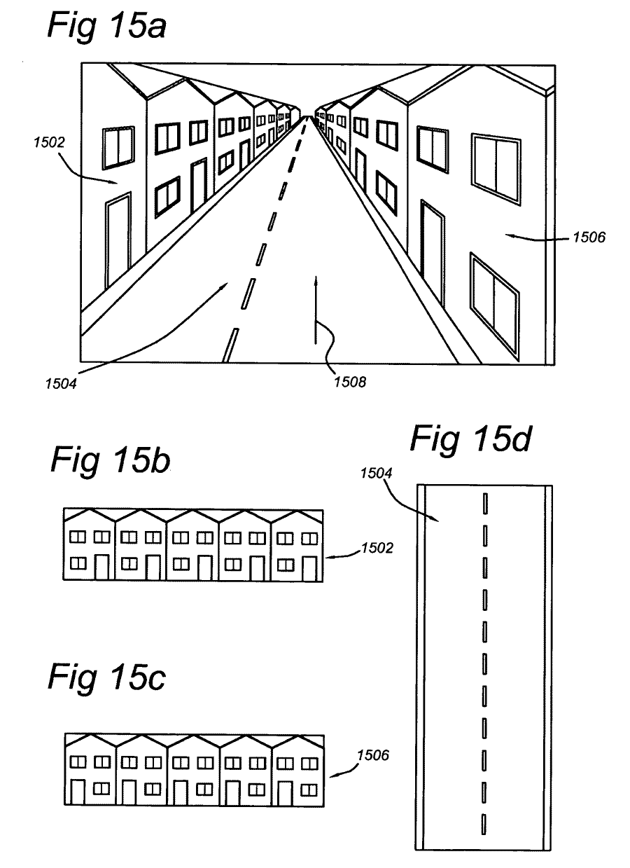

FIG. 15a-15d show an application of roadside panoramas produced by the invention. The application enhances the visual output of current navigation systems and navigation applications on the Internet. A device performing the application does not need dedicated image processing hardware to produce the output. FIG. 15a shows a pseudo perspective view of a street that could be produced easily without using complex 3D models of the buildings at the roadside. The pseudo perspective view has been obtained by processing the left and right roadside panorama of said street and a map generated likeness of the road surface (earth surface) between the two multi viewpoint panoramas. The map and two images could have been obtained by processing the images sequences and position/heading data that have been recorded during a mobile mapping session, or could have used the images for the virtual planes and combined it with data derived from a digital map database. FIG. 15b shows the roadside panorama of the left side of the street and FIG. 15c shows the roadside panorama of the right side of the street. FIG. 15d shows a segment expanded from a map database or could also be from orthorectified image of the street also collected from the mobile mapping vehicle. It can be seen that by means of a very limited number of planes a pseudo-realistic view of a street can be generated. References 1502 and 1506 indicate the parts of the image that has been obtained by making a pseudo perspective view of the panoramas of FIGS. 15b and 15c respectively. The parts 1502 and 1506 can easily be generated by transforming the panorama of FIGS. 15b and 15c into a perspective view image by projecting sequentially the columns of pixels of the roadside panorama on the pseudo-realistic view, starting with the column of pixels with the farthest position from the viewing position up to the column of pixels with nearest position from the viewing point. Reference 1504 indicates the part of the image that has been obtained by making an expansion of the map database or a perspective view of the orthorectified image of the road surface.

It should be noted that in the pseudo perspective view image, all buildings at a side of the road have the same building line and hence it cannot be a complete perspective view. In reality, each building could have its own building line. In panoramas captured by a slit-scan camera, the buildings will then have different sizes. Using this type of panorama in the present application would result in a strange looking perspective view image. Different perpendicular distances between the buildings and the road will be interpreted as different height and size of the building in the perspective view image. The invention enables the production of a reasonably realistic view image in such a case at a small fraction of the processing power needed for a more complete 3D representation. According to the method according to the invention a roadside panorama for a street is generated in two steps. Firstly, for the building along the street a one or more multi viewpoint panorama will be made. Secondly, a roadside panorama is generated by projecting the one or more multi viewpoint panorama on one common smooth surface. In an embodiment the common smooth surface is parallel to a line along the road, e.g. track line of car, centerline, borderline(s). “Smooth” means that the distance between the surface and line along the road may vary, but not abruptly.

In the first action, a multi viewpoint panorama is generated for each smooth surface along the roadside. A smooth surface can be formed by one or more neighboring building facades having the same building line. Furthermore, in this action as much as possible obstacles in front of the surface will be removed. The removal of obstacles can only be done accurately when the determined position of a surface corresponds to the real position of the façade of the building. The orientation of the surface along the road may vary. Furthermore, the perpendicular distance between the direction of the road and the surface of two neighboring multi viewpoint panoramas along the street may vary.

In the second action, from the generated multi viewpoint panoramas in the first action, a roadside panorama is generated. The multi viewpoint panorama is assumed to be a smooth surface along the road, wherein each pixels is regarded to represent the surface as seen from a defined distance perpendicular to said surface. In a roadside panorama according to the invention the vertical resolution of each pixel of the roadside panorama is similar. For example, a pixel represents a rectangle having a height of 5 cm. The roadside panorama used in the application is a virtual surface, wherein each multi viewpoint panorama of buildings along the roadside is scaled such that it has a similar vertical resolution at the virtual surface. Accordingly, a street with houses having equivalent frontages but differing building line will be visualized in the panorama as houses having the same building line and similar frontages.

To the roadside panorama as described above, depth information can be associated along the horizontal axis of the panorama. This enables applications running on a system having some powerful image processing hardware, to generate a 3D representation from the panorama according to the real positions of the buildings.

In current digital map databases, streets and roads are stored as road segments. The visual output of present applications using a digital map can be improved by associating in the database with each segment, a left and right roadside panorama and optionally an orthorectified image of the road surface of said street. In the digital map the position of the multi viewpoint panorama can be defined with absolute coordinated or coordinates relative to a predefined coordinate of the segment. This enables the system to determine accurately the position of a pseudo perspective view of a panorama in the output with respect to the street.

A street having crossing or junctions, will be represented by several segments. The crossing or junction will be a start or end point of a segment. When for each segment the database comprises associated left and right roadside panorama, a perspective view as shown in FIG. 15a can be generated easily by making a perspective view of the left and right roadside panoramas associated with the segments of the street visible and at reasonable distance. FIG. 15a is a perspective view image generated for the situation that a car has a driving direction parallel to the direction of the street. Arrow 1508 indicates the orientation and position of the car on the road. As a panorama is generated for the most common plane, a panorama will start with the most left building and end with the most right building of the roadside corresponding to a road segment. Consequently, no panorama is present for the space between buildings at a crossing. In one embodiment, these parts of the perspective view image will not be filed with information. In another embodiment, these parts of the perspective view image will be filed with the corresponding part of the panoramas associated with the segments coupled to a crossing or junction and the expanded map data or orthorectified surface data. In this way, two sides of a building at the corner of a crossing will be shown in the perspective view image.

In a navigation system without dedicated image processing hardware, while driving a car, the display can still be frequently refreshed, e.g. every one second in dependence of the traveled distance. In that case, every second a perspective view will be generated and outputted based upon the actual GPS position and orientation of the navigation device.

Furthermore, a multi viewpoint panorama according to the invention is suitable to be used in an application for easily providing pseudo-realistic views of the surrounding of a street, address or any other point of interest. For example, the output present route planning systems can easily enhance by adding geo referenced roadside panorama according to the invention, wherein the facades of the buildings have been scaled to make the resolution of the pixels of the buildings equal. Such a panorama corresponds to a panorama of a street wherein all buildings along the street have the same building line. A user searches for a location. Then the corresponding map is presented in a window on the screen. Subsequently, in another window on the screen (or temporarily on the same window) an image is presented according to the roadside perpendicular to the orientation of the road corresponding to said position (like that of FIG. 15b or 15c. In another implementation, the direction of the map on the screen could be used to define in which orientation a perspective view of the panorama should be given. All pixels of the roadside panorama are regarded to represent a frontage at the position of the surface of the roadside panorama. The roadside panorama only comprises visual information that is assumed to be on the surface. Therefore, a pseudo-realistic perspective view can easily be made for any arbitrary viewing angle of the roadside panorama. By a rotation function of the system, the map can be rotated on the screen. Simultaneously, the corresponding perspective pseudo-realistic image can be generated corresponding to the rotation made. For example, when the direction of the street is from the left to the right side of the screen representing corresponding part of the digital map, only a part of the panorama as shown in FIG. 15b will be displayed. The part can be displayed without transforming the image as the display is assumed to represent a roadside view, which is perpendicular to the direction of the street. Furthermore, the part shown corresponds to a predetermined region of the panorama left and right from the location selected by the user. When the direction of the street is from the bottom to the top of the screen, a perspective view like FIG. 15a will be produced by combining the left and right roadside panorama and optionally the orthorectified image of the road surface.

The system could also comprise a flip function, to rotate the map by one instruction over 180° and to view the other side of the street.

A panning function of the system could be available for walking along the direction of the street on the map and to display simultaneously the corresponding visualization of the street in dependence of the orientation of the map on the screen. Every time a pseudo-realistic image will be presented as the images used, left and right roadside panorama and orthorectified road surface image (if needed) represent rectified images. A rectified image is an image wherein each pixel represents a pure front view of the buildings facades and top view of the road surface.

FIGS. 15b and 15c show roadside panoramas of a street wherein all houses have the same ground level. However, it is obvious to the person skilled in the art that the method described above normally will generate a road side panorama wherein houses with different ground levels will be shown in the roadside panorama as different heights. FIG. 18 shows such a roadside panorama. In the roadside panorama, only the pixels corresponding to the surfaces representing the multi viewpoint panoramas along the road should be shown on a display. Therefore, the pixels in the areas 1802 and 1804 should not be taken into account when reproducing the roadside panorama on a display. Preferably, said areas 1802 and 1804 will be given a value, pattern or texture that enables to detect where borderline of area of the object along the roadside is. For example, the pixels in said areas 1802 and 1804 will obtain a value which normally is not present in images, or in each column of pixels, the value of the pixels starts with a first predefined value and is ended with a pixel having a second predefined value, wherein the first predefined value differs from the second predefined value. It will be noted that buildings on a hill could have frontage wherein the ground level has a slope. This will then also be seen in the multi viewpoint panorama of the frontage and the road side panorama comprising said multi viewpoint panorama.

There are applications which visualize height information of a road when producing on a screen a perspective view image of a digital map. A roadside panorama as shown in FIG. 18 is very suitable for use in those applications to provide a pseudo-realistic perspective view of a street. The height of the road surface will match in most occasions to the ground level of the frontage. The multi viewpoint panorama of a frontage could have been projected on the surface associated with the roadside panorama. In that case the height of the road surface could not match, with the height of the ground level of the frontage. The application could be provided with an algorithm which detects a difference between the heights of the road surface and the ground level of the frontage in the multi viewpoint panorama. Therefore, the application is arranged to determine in each column of pixels the vertical position of the lowest position of a pixel corresponding to objects represented by the roadside panorama by detecting the position of the top pixel of area 1802. As each pixel represents an area with a predetermined height, the difference in height between road surface and ground level can be determined. This difference along the street is subsequently used to correct the height of the frontage in the panorama and to generate a pseudo perspective view image of the road surface with road sides, wherein the height of the road surface matches the height of the ground level of the frontage.

There are applications which use maps which do not comprise height of the roads. Therefore they are only suitable for producing a perspective view of a horizontal map. Combination of the roadside panorama of FIG. 18 would result in a perspective view image, wherein the ground level of the buildings is varying along the road. This inconsistency may not look realistic. Two embodiments will be given in which these applications could provide pseudo realistic perspective view image.

In the first embodiment, the application will derive the height information from the roadside panorama and use the height information to enhance the perspective view of the horizontal map. Therefore, the application is arranged to determine in each column of pixels the vertical position of the lowest position of a pixel corresponding to objects represented by the roadside panorama by detecting the position of the top pixel of area 1802. As each pixel represents an area with a predetermined height, the difference in height along the street can be determined. This difference along the street is subsequently used to generate a pseudo perspective view image of the road surface which visualizes the corresponding difference in heights along the street. In this way, the roadside panorama and road surface can be combined wherein in the pseudo-realistic perspective view image the road surface and the surface of roadside view will be contiguous. It is obvious for one skilled in the art, that if a road surface with varying height has to be generated according to the frontage ground levels shown in FIG. 18, a road surface should be generated that increases/decreases gradually. Preferably, a smoothing function is applied to the ground levels along the street derived from the roadside panorama. The result of this is a smoothly changing height of the road surface, which is a much more realistic view of a road surface.

In the second embodiment, in contrary to the first embodiment, the application will remove the area 1802 from the roadside panorama and use the thus obtained image to be combined with the horizontal map. Removal of the area 1802 will result in an image similar to a road side panorama is shown in FIG. 15c. By removing the height information from the roadside panorama, a pseudo-realistic perspective view image is generated, representing a horizontal road surface with along the road buildings all having the same ground level. In the event, the ground level of a façade in the roadside panorama has a slope, the slope could be seen in the pseudo-realistic perspective view image by distortion of the visual rectangularity of doors and windows.

The foregoing detailed description of the invention has been presented for purposes of illustration and description. It is not intended to be exhaustive or to limit the invention to the precise form disclosed, and obviously many modifications and variations are possible in light of the above teaching. For example, instead of using the source images of two or more cameras, the image sequence of only one camera could be used to generate a panorama of a building surface. In that case two subsequent images should have enough overlap, for instance >60%, for a façade at a predefined distance perpendicular to the track of the moving vehicle.

The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. Method of producing a multi-viewpoint panorama of a roadside comprising:
acquiring a set of laser scan samples obtained by at least one terrestrial based laser scanner mounted on a moving vehicle, wherein each sample of the set of laser scan samples is associated with location data and orientation data;
acquiring at least one image sequence, wherein each image sequence of the at least one image sequence is obtained by use of a terrestrial based camera mounted on the moving vehicle, wherein each image of the at least one image sequences is associated with location and orientation data;
extracting a surface from the set of laser scan samples and determining a location of the extracted surface in dependence of the location data associated with the set of laser scan samples; and
producing a multi-viewpoint panorama for the extracted surface from the at least one image sequence in dependence of the location of the extracted surface and the location and orientation data associated with each image of the at least one image sequence.

2. Method according to claim 1, wherein the producing comprises:
detecting an obstacle obstructing in a first image of the at least one image sequences to view to a part of the surface;
selecting an area of a second image of the at least one image sequence which visualizes the part of the surface; and
using the selected area of the second image to produce the part of the surface in the producing of the multi viewpoint panorama.

3. Method according to claim 1, wherein the producing comprises:
detecting one or more obstacles obstructing in all images of the at least one image sequences to view a part of the surface; and
projecting a view of one of the one or more detected obstacles in the producing of the multi-viewpoint panorama.

4. Method according to claim 3, wherein the producing further comprises:
determining, for each of the detected one or more obstacles, whether the detected one or more obstacles is completely visible in any of the images of the at least one image sequence; and
projecting, if a detected obstacle is completely visible in at least one image of the at least one image sequence, a view of said detected object from one of said at least one image to the multi-viewpoint panorama.

5. Method according to claim 1, wherein the multi-viewpoint panorama is generated from parts of images having an associated looking angle which is most perpendicular to the surface.

6. Method according to claim 1, wherein the producing comprises:
generating a master shadow map for the surface; and
producing the multi-viewpoint panorama in dependence of the generated master shadow map.

7. Method according to claim 6, wherein the generating of the master shadow map comprises:
selecting images of the at least one image sequence having a viewing window which includes at least a part of the surface;
generating a shadow map for each selected image by projecting a shadow of an obstacle in front of the surface which is visualized in the corresponding selected image; and
combining the generated shadow maps of the selected images to obtain the master shadow map.

8. Method according to claim 6, wherein the producing further comprises:
splitting the master shadow map into segments;
determining, for each of the segments, a corresponding image of the at least one image sequence having no obstacle in its associated viewing window; and
using said determined corresponding image to project the area associated to said segment on the multi-viewpoint panorama.

9. Method according to claim 8, wherein the producing further comprises:
using, if no corresponding image for a segment is determined, an image of the at least one image sequence having the whole obstacle in its associated viewing window.

10. Method according to claim 8, wherein the producing further comprises:
using, if no corresponding image for a segment is determined, the image of the at least one image sequence having an associated looking angle which is most perpendicular to the surface

11. Method according to claim 1, wherein the surface is extracted by performing a histogram analysis on the set of laser scan samples.

12. Method of producing a roadside panorama comprising:
retrieving multiple multi-viewpoint panoramas, at least one of which was generated by the method of claim 1 and associated position information;
determining the position of a virtual surface for the roadside panorama; and
projecting the multiple multi-viewpoint panoramas on the virtual surface.

13. An apparatus, comprising:
an input device;
a processor readable storage medium;
a processor in communication with said input device and said processor readable storage medium; and
an output device to enable connection with a display unit; said processor readable storage medium storing code to program said processor to perform a at least the actions of:
acquiring a set of laser scan samples obtained by at least one terrestrial based laser scanner mounted on a moving vehicle, wherein each sample of the set of laser scan samples is associated with location data and orientation data,
acquiring at least one image sequence, wherein each image sequence of the at least one image sequence is obtained by use of a terrestrial based camera mounted on the moving vehicle, wherein each image of the at least one image sequences is associated with location and orientation data;
extracting a surface from the set of laser scan samples and determining a location of the extracted surface in dependence of the location data associated with the set of laser scan samples; and
producing a multi-viewpoint panorama for the extracted surface from the at least one image sequence in dependence of the location of the extracted surface and the location and orientation data associated with each image of the at least one image sequence.

14. A computer program product comprising
instructions, which when loaded on and executed on a computer arrangement, allows said computer arrangement to perform the method according to claim 1.

15. A processor readable medium carrying a computer program product which, when loaded on and executed on a computer arrangement, allows said computer arrangement to perform the methods according to claim 1.

16. A processor readable medium carrying a multi viewpoint panorama obtained by performing the methods according to claim 1.

17. A computer-implemented system that provides, simultaneously on a screen, a map and a selected location in a street and a pseudo-realistic view from the location, comprising:
a map comprising the selected location;
at least one roadside panorama obtained according to the method of claim 11;
a map generating component for displaying with a variable orientation on a screen a display map including the selected location in a street; and
a view generating component for generating a pseudo-realistic view for the selected location from said at least one roadside panorama in dependence of the variable orientation.

18. A computer-implemented system according to claim 17, wherein the map and the pseudo-realistic view are combined into one pseudo perspective view.

19. Method according to claim 2, wherein the multi-viewpoint panorama is generated from parts of images having an associated looking angle which is most perpendicular to the surface.

20. Method according to claim 7, wherein the producing further comprises:
splitting the master shadow map into segments;
determining, for each of the segments, a corresponding image of the at least one image sequence having no obstacle in its associated viewing window; and
using said determined corresponding image to project the area associated to said segment on the multi-viewpoint panorama.

21. Method according to claim 20, wherein the producing further comprises:
using, if no corresponding image for a segment is determined, an image of the at least one image sequence having the whole obstacle in its associated viewing window.

22. Method according to claim 2, wherein the surface is extracted by performing a histogram analysis on the set of laser scan samples.

23. Method according to claim 3, wherein the surface is extracted by performing a histogram analysis on the set of laser scan samples.

24. A computer readable medium including program segments for, when executed on a computer device, causing the computer device to implement the method of claim 1.
